(19) United States
(12) Patent Application Publication
(10) Pub. No.: US 2016/0107561 A1
(43) Pub. Date: Apr. 21, 2016

(54) STORAGE RACKING SYSTEM FOR COLD CHAIN LOGISTICS

(71) Applicant: Mustafa Serdar Senaydin, Doral, FL (US)

(72) Inventor: Mustafa Serdar Senaydin, Doral, FL (US)

(21) Appl. No.: 14/519,104

(22) Filed: Oct. 20, 2014

(51) Int. Cl. B60P 3/20; B60H 1/00

(52) U.S. Cl. CPC B60P 3/20; B60H 1/00357

(57) ABSTRACT

A storage racking system for cold chain logistics, comprising: a basic unit; an air guidance unit for providing horizontal and vertical air flow, which comprises an air plenum group, a pallet stop group with fixed or pivoting features and at least one U-shaped guiding rail for blocking air; the air plenum group comprises a primary negative pressure air plenum and a pair of secondary negative pressure air plenums; the pallet stop group comprises a first pallet stop and a plurality of second pallet stops; and at least one air moving unit for sucking air and providing vacuum or blowing air flow, which comprises a plurality of forced air modules and a plurality of auxiliary fans.

### BACKGROUND

Significant percentage of pharmaceuticals, floral products, fast moving-highly perishable foods, like fresh fruits and vegetables are wasted due to lack of air during cold chain logistics.

Currently used Refrigerated Storage and Reefer transportation units (containers and trailers) are designed to maintain conditioned air at desired levels. However, most common methods of perishable transportation including reefer and standard unconditioned vehicles, do not have any or adequate air circulation through the tightly packed boxes. Air delivery provided in these vehicles by their standard refrigeration equipment slowly reaches the product through the surface working toward the core by convection heat transfer.

Poor air circulation will raise the perishable commodity's temperature. Relative humidity and ethylene and carbon dioxide accumulation during processing also raise the core temperatures. Conditioned cold air alone cannot circulate properly in the basic cold room, during transportation or retail display. Further during this long journey from “farm to fork”, additional heat is generated by limited air circulation. Therefore, the expected shelf lives of the perishable products are significantly reduced, which results in weight loss, fungus and premature decay or total loss.

### SUMMARY OF THE INVENTION

The objective of the present invention is to provide ample guided air circulation throughout the entire Cold Chain Logistics. The most common practical feature of any small or large scale warehouses and distribution centers are the use of storage racks.

In one embodiment, a storage racking system for cold chain logistics is disclosed, which comprises a basic unit; an air guidance unit for providing horizontal and vertical air flow, which comprises an air plenum group, a pallet stop group with fixed or pivoting features and at least one U-shaped guiding rail for blocking air; the air plenum group comprises a primary negative pressure air plenum and a pair of secondary negative pressure air plenums; the pallet stop group comprises a first pallet stop and a plurality of second pallet stops; and at least one air moving unit for sucking air and providing vacuum or blowing air flow, which comprises a plurality of forced air modules and a plurality of auxiliary fans.

### BRIEF DESCRIPTION OF THE DRAWINGS

FIG. 1 shows a schematic front view of the storage racking system.

FIG. 2 shows a schematic rear view of the storage racking system.

FIG. 3 shows a partial sectional view along A-A line of FIG. 1.

FIG. 4 shows a schematic side view of the storage racking system.

FIG. 5 shows a schematic view of the air moving module and the passive cooling unit of the storage racking system.

FIG. 6 shows a schematic view of the operation of the units of the storage racking system.

### DETAILED DESCRIPTION OF PREFERRED EMBODIMENTS

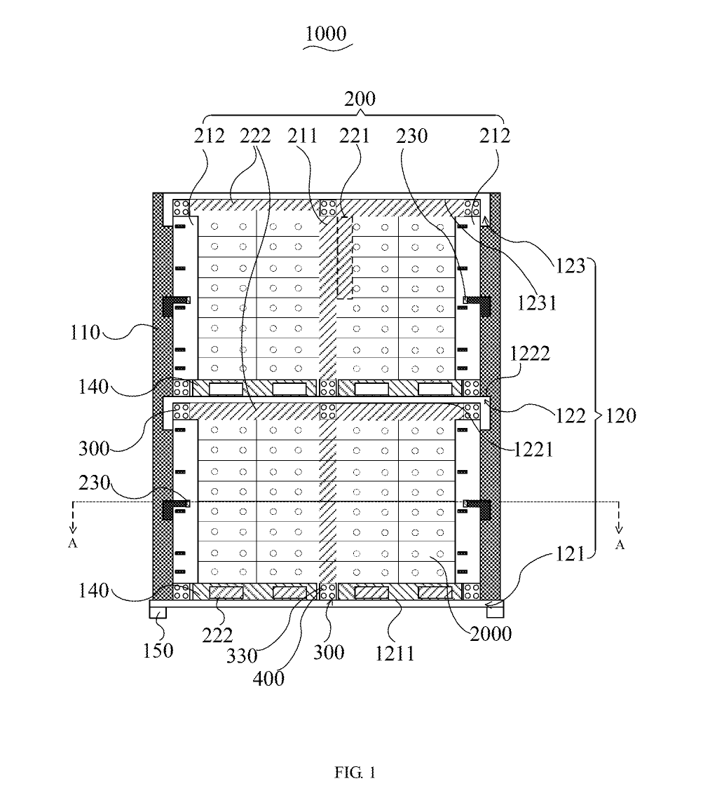

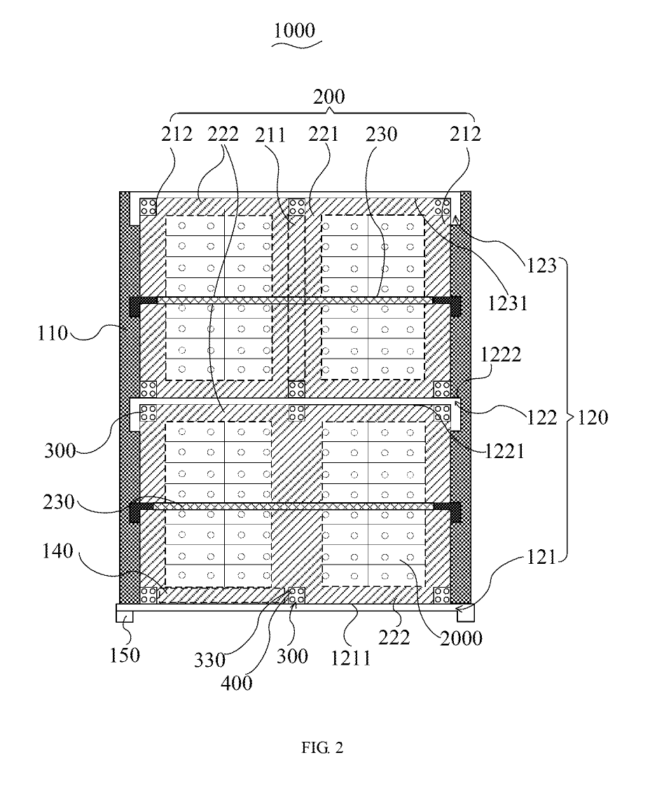

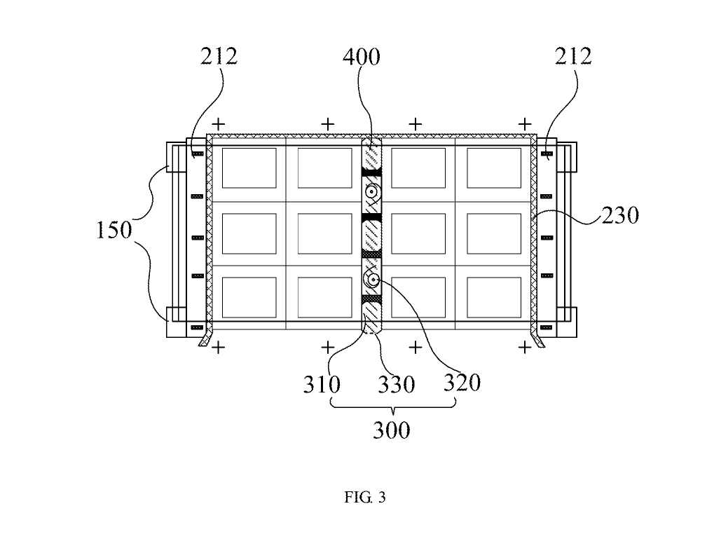

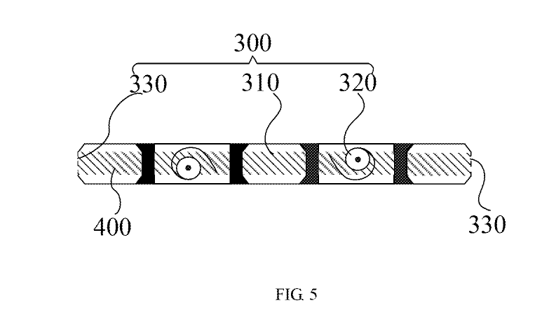

An embodiment of the invention is illustrated in FIGS. 1-6. Storage racking system 1000 for cold chain logistics comprises basic unit 100, air guidance unit 200, and at least one air moving unit 300.

Basic unit 100 is a fundamental structure, which comprises four legs 110, six horizontal beams 120, and a plurality of Z-shaped bracings 130. As illustrated in FIG. 1, four legs 110 and six horizontal beams 120 form two layers, and therefore four storage spaces for containing a plurality of pallets 140 are formed; horizontal beams 120 are divided into three groups, a first group comprising two bottom horizontal beams 121 connected with lower end of base unit 100 and in the position of the lower ends of four legs 110, a second group comprising two middle horizontal beams 122 connected anywhere, as multiple sets, with the middle of legs 110, a third group comprising the two top horizontal beams 123 connected with supporting base clips 150 of base unit 100 and in the position of the top ends of four legs 110. Further, each of the storage space comprises a top surface, a bottom surface, a front surface, a rear surface and two side surfaces which are defined by the assembly of legs 110 and horizontal beams 120. In another embodiment, the number of horizontal beams 120 may be adjustable and multiple; therefore, the number of the layer of basic unit 100 may be adjustable accordingly. Multiple basic units 100 can be combined either horizontally or vertically or both horizontally and vertically to form storage racking system 1000. Thereby multiples of storage racking system 1000 and any combination thereof will improve space utilization and air circulation in cold chain logistics.

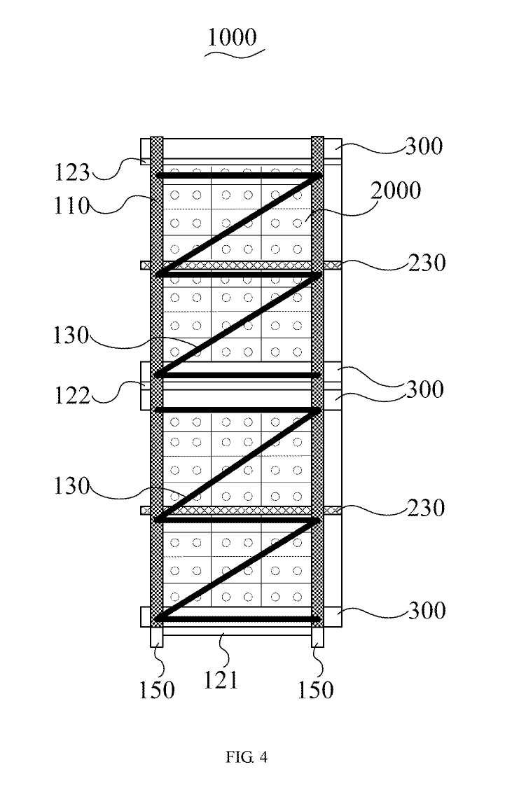

Please refer to FIG. 4, in which Z-shaped bracings 130 are arranged vertically along the height-wise direction of basic unit 100. Z-shaped bracings 130 are disposed on the two side surfaces and connected tightly with legs 110. Multi-layer structure of basic unit 100 is realized with the cooperation of legs 110, horizontal beams 120 and Z-shaped bracings 130. Pallets 140 are disposed on top surface 1211 of bottom horizontal beams 121 and top surface 1222 of middle horizontal beams 122, which are used for containing perishable products 2000.

This design and its components may be fitted into existing racks easily. Modifications can also be easily made and will improve air circulation in any racked or non-racked cold chain logistics facilities.

Pallets 140 are available to be used with EURO 800×1200 & 1000×1200 mm and GMA 40×48″, and sharing the same foot print of a standard storage or display racking. The frame of pallet 140 is made of wood, load bearing reinforced plastic or metal; and the metal may be steel or aluminum. The frame of the pallet measures; with legs about 125-160 mm (5-6″) height, 160 or 170 mm (6-7″) width and 1000 or 1200 mm (40″×48″) top loading area.

Air guidance unit 200 is used for providing horizontal and vertical air flows in storage racking system 1000. Air guidance unit 200 comprises an air plenum group, a pallet stop group and at least one guiding rail 230. The air plenum group allows desired air flow, which comprises primary negative pressure air plenum 211 as a central plenum disposed in the middle of base unit 100 and from top horizontal beams 123 to bottom horizontal beams 121. The air plenum group also comprises a pair of secondary negative pressure air plenums 212 which are side plenums disposed on side surfaces of basic unit 100, by the two sides of primary negative pressure air plenum 211 and from top horizontal beams 123 to bottom horizontal beams 121.

The pallet stop group comprises first pallet stop 221 and second pallet stops 222. First pallet stop 221 comprises at least one vertical stop disposed along primary negative pressure air plenum 211. Second pallet stops 222 are horizontally disposed on six horizontal beams 120 and adjacent air moving units 300. That is, second pallet stops 222 are respectively disposed on the top, middle and bottom of system 1000. The pallet stop group blocks positive air and make the positive air available surrounding pallets 140 to move through the holes of the boxes on perishable products 2000. Alternatively, an opening is disposed on pallet stop group and with a size smaller than pallet 140. The size of the opening is about 8″ or 200 mm less in width than that of pallet 150 and 12″ or 300 mm less in height than that of pallet 140.

In the present embodiment, as can be seen in FIGS. 1-4, there are two guiding rails 230 disposed vertically along the height-wise direction of basic unit 100 and respectively clamped with the inner sides of legs 110. Guiding rail 230 is U-shaped from the top view. Alternatively, the number of guiding rails may be adjustable according to practical needs. The position of guiding rails 230 is also adjustable for vertical adjustment of air flow.

Air moving unit 300 is interchangeable, and used for sucking air, providing vacuum or negative pressure, blowing air flow, providing horizontal or vertical air discharge. Alternatively, air moving unit 300 is further capable of providing misting moist air in tandem with controlled humidity. In this embodiment, there is one or more air moving units 300 disposed below or above the horizontal beams and within basic unit 100 and sub members 121, 122 and 123. The air moving units are divided into four groups, wherein the first group of air moving units are disposed on top surface 1211 of bottom horizontal beams 121; the second group of air moving units are disposed on bottom surface 1221 of the middle horizontal beams 122; the third group of air moving units are disposed on top surface 1222 of middle horizontal beams 122; and the fourth group of air moving units are disposed on bottom surface 1231 of top horizontal beams 123. Each of air moving unit 300 comprises forced air modules 310 and auxiliary fans 320. In the present embodiment, the auxiliary fan 320 is an axial or a centrifugal fan.

Air moving unit 300 is in rectangular shape, as illustrated in FIGS. 1-3 and 5, in which a plurality of openings 330 are disposed on the front surface of air moving unit 300 for allowing air circulation. Forced air module 310 and auxiliary fans 320 work independently, as predetermined, and forced air module 310 may be turned on and work separately without turning on auxiliary fans 320.

Storage racking system 1000 further comprises at least one passive cooling unit 400 disposed within air moving units 300, as illustrated in FIGS. 1-3 and 5, passive cooling unit 400 could be viewed from openings 330 of air moving unit 200. Passive cooling unit 400 is equipped with passive cooling tubes or coils and is rechargeable with phase-change material. The phase-change material is selected from organic salt and renewable ice. Passive cooling unit 400 may be disposed on anywhere of system 1000.

Storage racking system 1000 further comprises remote control unit 500 for turning on or off system 1000, and controlling the operation of air moving unit 300 remotely. Remote control unit 500 is adaptable for smart device controlled features, and the features comprises IOS and Android features; and remote control unit 500 is in compliant with wireless control, and the type of the wireless control comprises RFID, Wi-Fi and ZigBee.

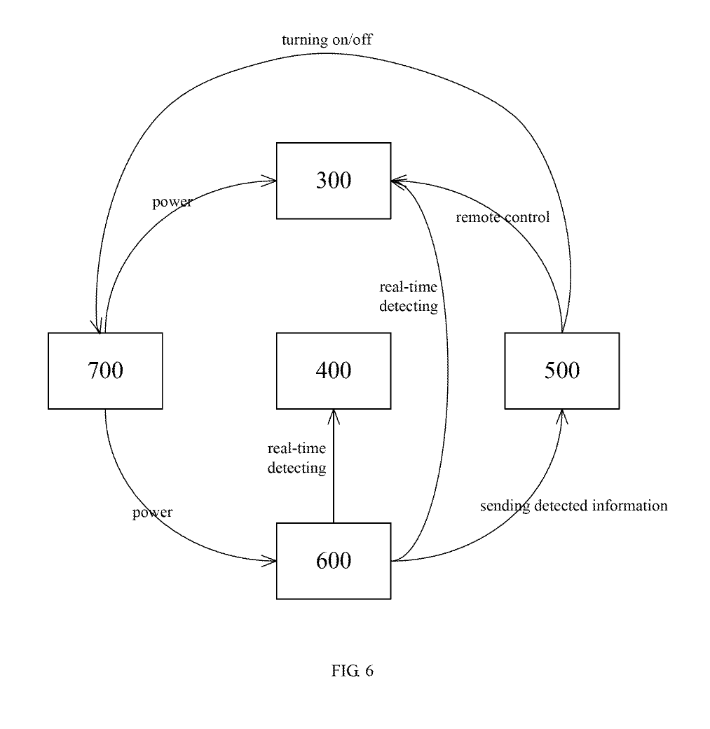

Storage racking system 1000 further comprises sensor unit 600 for real-time sensing. Sensor unit 600 detects the temperature, air circulation and humidity in system 1000, and detects the working status of air guidance unit 200 and air moving unit 300, then sends the detected information to remote control unit 500. As illustrated in FIG. 6, storage racking system 1000 therefore has the function of real-time monitoring, detecting, recording and alarming.

Storage racking system 1000 further comprises power supply 700 AC/DC/EC operated with AC-DC-EC (direct, alternating or electronic current) powered stationary or rechargeable battery, a in-rack fire suppressant unit, and an optional LED lighting unit of system 1000 for improving visibility.

Optional power adaptor, high efficiency or standard rechargeable battery, and battery charger assembly is used as accessories for storage racking, holding and displaying shelves.

In another optional embodiment, storage racking system 1000 is capable of providing recirculation (or non-recirculation) air flow.

The invention by using multiples of the described system 1000 arrayed vertically, horizontally and back to back, keeping proper air circulation in a high cube and high volume storage environment provides uniform air temperature and humidity so that it extends the shelf-life of perishables like fruits and vegetables. The temperature spread within system 1000 is about or less than +/−1° C. Significantly reducing or eliminating heat generated after harvest and during the “COLD CHAIN” logistics or handling, the perishables, mainly the food items “from farm to fork” will benefit with longer shelf life.

This invention is related to a stationary (or if desired) portable and interlocking sectional construction of storage rack system: this rack assembly will be used in cold chain logistics, warehousing and storage. Together with an air assisted platform/module 300 embedded in a known “standard” storage racking, such as deep reach, drive-in, drive-thru or the like. This design may also be used as a display shelf in retail outlets for presentation of the perishable products.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

I claim:

1. A storage racking system for cold chain logistics, comprising:
a basic unit;
an air guidance unit for providing horizontal and vertical air flow, which comprises an air plenum group, a pallet stop group with fixed or pivoting features and at least one U-shaped guiding rail for blocking air; the air plenum group comprises a primary negative pressure air plenum and a pair of secondary negative pressure air plenums; the pallet stop group comprises a first pallet stop and a plurality of second pallet stops; and
at least one air moving unit for sucking air and providing vacuum or blowing air flow, which comprises a plurality of forced air modules and a plurality of auxiliary fans.

2. The storage racking system according to claim 1, wherein the basic unit comprises four legs and six horizontal beams for forming at least one storage space, the storage space comprising a top surface, a bottom surface, and four side surfaces;
at least a pair of Z-shaped bracings respectively disposed on the two of the opposite side surfaces; and a plurality of pallets disposed on the top surface of the horizontal beams.

3. The storage racking system according to claim 2, wherein the basic unit is a fundamental structure, multiple base unit is capable of being combined either horizontally or vertically or both horizontally and vertically to form the storage racking system.

4. The storage racking system according to claim 2, wherein the Z-shaped bracings are capable of being arranged vertically along the height-wise direction of the base unit.

5. The storage racking system according to claim 1, wherein the basic unit is made of metal or load bearing reinforced plastic; the metal is selected from a group of steel, aluminum or the like.

6. The storage racking system according to claim 1, wherein the primary air plenum is a central plenum and the secondary air plenums are side plenums disposed on side surfaces of the basic unit and by the two sides of the primary air plenum.

7. The storage racking system according to claim 6, wherein the first pallet stop comprises at least one vertical stop disposed along the primary air plenum and the second pallet stops are horizontally disposed near the air moving units.

8. The storage racking system according to claim 1, wherein the air moving unit is further capable of providing negative pressure.

9. The storage racking system according to claim 8, wherein the air moving unit is further capable of providing horizontal or vertical air discharge.

10. The storage racking system according to claim 8, wherein the air moving units are respectively disposed on the top surfaces and the bottom surfaces of the horizontal beams.

11. The storage racking system according to claim 8, wherein the auxiliary fan is an axial or a centrifugal fan.

12. The storage racking system according to claim 1, further comprising at least one passive cooling unit which comprises passive cooling tubes or coils and rechargeable with phase-change material.

13. The storage racking system according to claim 12, wherein the phase-change material comprises organic salt and renewable ice.

14. The storage racking system according to claim 1, further comprising a remote control unit for real-time monitoring and controlling; the remote control unit is adaptable for smart device controlled features; and the remote control unit is in compliant with wireless control, and the type of the wireless control comprises RFID, Wi-Fi and ZigBee.

15. The storage racking system according to claim 1, further comprising:
a power supply AC/DC/EC operated with AC-DC-EC (alternating, direct or electronic current) powered stationary or rechargeable battery;
an in-rack fire suppressant unit; and
an optional LED lighting unit for improving visibility.

16. The storage racking system according to claim 1, wherein the temperature spread within the system is about or less than +/−1° C.
